(19) United States
(12) Patent Application Publication
(10) Pub. No.: US 2021/0136036 A1
(43) Pub. Date: May 6, 2021

(54) Multi UE and Multi Message Support in Tunnel Management Messages

(71) Applicant: Parallel Wireless, Inc., Nashua, NH (US)

(72) Inventors: Vinay Goutham Pullela, Nashua, NH (US); Manisha Sameer Gambhir-Parekh, Pune (IN)

(21) Appl. No.: 17/087,513

(22) Filed: Nov. 2, 2020

Related U.S. Application Data
(60) Provisional application No. 62/929,578, filed on Nov. 1, 2019.

(51) Int. Cl. H04L 29/06; G06F 9/455

(52) U.S. Cl. CPC H04L 63/029; H04L 63/0245; H04L 63/166; G06F 2009/45587; H04L 69/161; G06F 9/45558; G06F 2009/45595; H04L 63/20

(57) ABSTRACT

A method and computer readable medium for providing accelerated lookup for ESP IPsec tunnels is presented. In one embodiment a method includes receiving an IP packet at a network stack; performing IPsec policy lookup of the IP packet to identify an ESP tunnel IP, thereby ensuring an inner IP is routable at an other end of the tunnel without installing a route for the inner IP at the network stack; performing a route lookup for the tunnel IP; and sending the IP packet across the ESP tunnel.

### CROSS-REFERENCE TO RELATED APPLICATIONS

This application claims priority under 35 U.S.C. § 119(e) to U.S. Provisional Pat. App. No. 62/929,578, filed Nov. 1, 2019, titled “Accelerated Route Lookup for ESP IPSec Tunnels” which is hereby incorporated by reference in its entirety for all purposes. The present application hereby incorporates by reference each of U.S. Pat. App. Pub. Nos. US20110044285, US20140241316; WO Pat. App. Pub. No. WO2013145592A1; EP Pat. App. Pub. No. EP2773151A1; U.S. Pat. No. 8,879,416, “Heterogeneous Mesh Network and Multi-RAT Node Used Therein,” filed May 8, 2013; U.S. Pat. No. 8,867,418, “Methods of Incorporating an Ad Hoc Cellular Network Into a Fixed Cellular Network,” filed Feb. 18, 2014; U.S. patent application Ser. No. 14/777,246, “Methods of Enabling Base Station Functionality in a User Equipment,” filed Sep. 15, 2016; U.S. patent application Ser. No. 14/289,821, “Method of Connecting Security Gateway to Mesh Network,” filed May 29, 2014; U.S. patent application Ser. No. 14/642,544, “Federated X2 Gateway,” filed Mar. 9, 2015; U.S. patent application Ser. No. 14/711,293, “Multi-Egress Backhaul,” filed May 13, 2015; U.S. Pat. App. No. 62/375,341, “S2 Proxy for Multi-Architecture Virtualization,” filed Aug. 15, 2016; U.S. patent application Ser. No. 15/132,229, “MaxMesh: Mesh Backhaul Routing,” filed Apr. 18, 2016, each in its entirety for all purposes, having attorney docket numbers PWS-71700US01, 71710US01, 71717US01, 71721US01, 71756US01, 71762US01, 71819US00, and 71820US01, respectively. This application also hereby incorporates by reference in their entirety each of the following U.S. Pat. applications or Pat. App. Publications: US20150098387A1 (PWS-71731U501); US20170055186A1 (PWS-71815U501); US20170273134A1 (PWS-71850US01); US20170272330A1 (PWS-71850US02); and Ser. No. 15/713,584 (PWS-71850US03). This application also hereby incorporates by reference in their entirety U.S. patent application Ser. No. 16/424,479, “5G Interoperability Architecture,” filed May 28, 2019; and U.S. Provisional Pat. Application No. 62/804,209, “5G Native Architecture,” filed Feb. 11, 2019.

### BACKGROUND

Existing behavior in Linux kernel stack or any DPDK based implementation or any other Network stack implementations:

A Network stack uses route table to route IP packets that are originated by the host system or packets coming from wire.

A route table contains all the needed route to send the packet out/forward on wire. If there is no explicit route available, a default route can be provided which is used by the stack implementation to send the packet out.

IPSec tunnels are established between VPN connection or two systems or two end points. IPSec provides security services to IP such as encryption, authentication, etc. Any IPSec tunnel has two attributes: Security Policy and Security Association. Security policies decide which tunnel should be used to send the IP packet. The packet is then encrypted and sent in to tunnel defined by Security association. The packet IP address is one of the parameters of Security policies. This can be private IP address or public IP address. This is also called the inner IP. The network stack implementation uses this IP to find a route in the routing table. If it finds a route, it used the selected Security Association to encrypt the IP packet and send it on wire. Once the packet is encrypted, the outer IP address is defined by Security Association. Once the packet is encrypted, the networking stack implementation will again lookup the route table for the Security Association's IP address. This route lookup decides where the packet is routed.

The first route lookup for inner IP is done to ensure that the IP is reachable from the host. The second route lookup for outer IP is eventually used to route the packet. For example, when a UE is attached to ePDG, each UE gets a private IP from PGW. Each UE establishes its own IPSec tunnel with ePDG. The first route lookup is of no use in ePDG. Please find FIG. 1 describing the ESP tunnel.

An IP Encapsulating Security Payload (ESP) tunnel is understood to mean a tunnel that complies with the ESP protocol described in IETF RFC 4303, hereby incorporated by reference in its entirety for all purposes.

### SUMMARY

A mechanism is disclosed to accelerate packet processing on a system which handles IPSec tunnels. The system can be any Network Stack implementation which implements IPSec processing. This mechanism uses the knowledge of Security Association end points to accelerate the route lookup instead of Security policy parameters.

In one embodiment, a method providing accelerated lookup for ESP IPsec tunnels is disclosed. The method includes receiving an IP packet; performing IPsec tunnel lookup, ensuring an inner IP is routable at an other end of the tunnel; performing a route lookup for tunnel IP; and sending the IP packet across the IPsec tunnel.

In another embodiment a non-transitory computer-readable medium contains instructions for providing accelerated lookup for ESP IPsec tunnels which, when executed, cause a system to perform steps comprising: receiving an IP packet; performing IPsec tunnel lookup, ensuring an inner IP is routable at an other end of the tunnel; performing a route lookup for tunnel IP; and sending the IP packet across the IPsec tunnel.

### BRIEF DESCRIPTION OF THE DRAWINGS

FIG. 1 is a showing a packet used in IPSec tunnel mode, in accordance with some embodiments.

FIG. 2 is a diagram showing standard packet processing and optimized packet processing, in accordance with some embodiments.

FIG. 3 is a schematic network architecture diagram for various radio access technology core networks.

FIG. 4 is an enhanced eNodeB for performing the methods described herein, in accordance with some embodiments.

FIG. 5 is a coordinating server for providing services and performing methods as described herein, in accordance with some embodiments.

### DETAILED DESCRIPTION

On a Linux kernel or DPDK based IPSec processing module or any other Network stack implementation, with each tunnel, the system needs to maintain route to inner IP as well as outer IP. On systems which need to establish huge number of tunnels, there are those many route entries for inner IP as well as outer IP. The inner IP route is eventually not used for routing the ESP packet. With huge number of tunnels, the route table lookup is impacted. This also slows down packet processing. So is installation of routes and tunnels on the system which impacts Tunnels per Second.

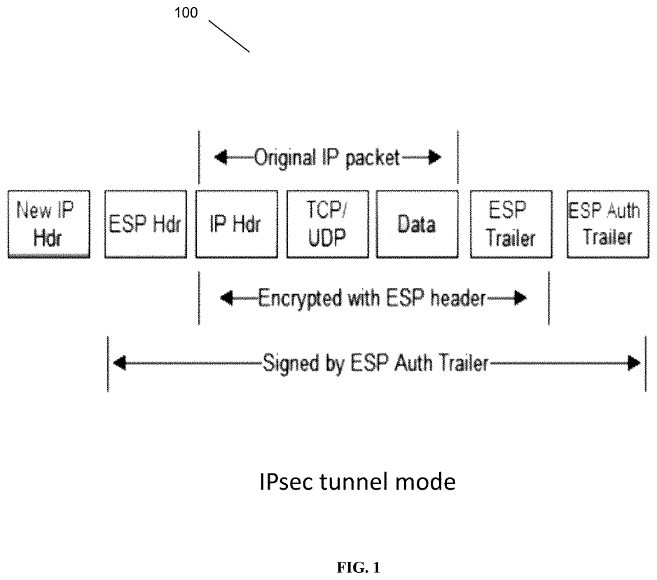

FIG. 1 shows a diagramof a packet 100 used in IPSec tunnel mode.

A problem arises when trying to develop a scalable solution supporting a large number of tunneling clients. A typical routing table is 10's or 100's of entries. However, if we create 1 tunnel per user, with 10000 subscribers, we add at least one route per user, creating a very large routing table that must be moved back and forth between user space and kernel space. Additionally, every packet requires a route lookup, introducing latency and scaling impact.

The present solution greatly improves tunnel setup speed and throughput by allowing us to avoid the route lookup. The storage footprint of the routing table is also reduced. Additional route-related steps can also be omitted as a result, e.g., fetching all the routes, sorting all the routes, finding a best route, changing, adding, deleting routes.

Instead of using routes, the present solution uses an IPsec policy to provide the required information. Typically, any client would know its own local IP, and the IP of the security gateway and end point. If a host can ping a security gateway, and the reverse packet comes back, then it is routable. But those may not be the IPs desired. E.g., with VPN, only certain traffic goes through the tunnel. Also, for the reverse path, the gateway needs to know where this local IP is hosted. In the present solution, we remove this route lookup, and instead of the route lookup, we are using the already-present IPsec policy.

In some embodiments, this is for data plane only and for an internal IP, which may not be directly reachable from other hosts or from hosts outside the operator network. In some embodiments, this is provided for a distributed network gateway, distributed heterogeneous network gateway, mesh network gateway, virtualization network gateway. In some embodiments, this is provided for packets sent from the gateway itself to other hosts. In some embodiments, this is provided for network management, heartbeats, and configuration messages.

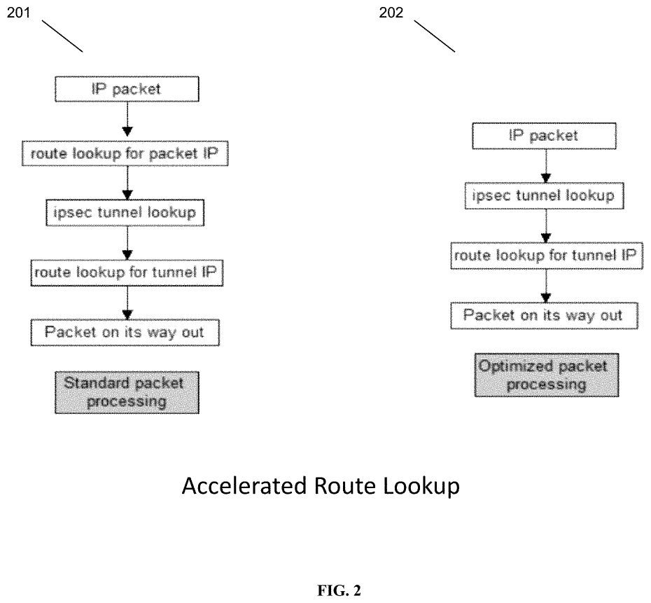

As shown in FIG. 2, the omission of the step “route lookup for packet IP”—packet IP is outer IP, tunnel IP is inner IP.

The present solution could apply to various embodiments, including an IPsec implementation in a kernel-space network stack, an IPsec implementation in a user space network stack, a non-IPsec implementation using other tunnels such as GTP tunnels, instruction set level, hardware- or firmware-accelerated network processing such as Intel DPDK/Fastpath, network stack processing in a virtualized environment using a virtual machine and/or containers, distributed network stack processing, top-of-rack network stack processing, etc. A brief discussion of the locality of network processing follows.

In a kernel-space networking stack, a networking packet takes the following path. When user a wants to send a packet to user b, data is passed to and through the operating system (OS) kernel, which adds IP headers, performs IPsec processing in the kernel, and hands off the processed packet to a network interface card (NIC). The NIC then sends the packet out on the wire. Then the packet goes to host b, goes to host b′s kernel, is processed there, then to a socket interface at the kernel, then to the user space application on host b.

In a user space networking stack, certain network tasks are offloaded to a user space networking stack by the user space application, by the user space application invoking processing by the user space networking library. There is no handover from user space to kernel space and vice versa. This can be faster in some cases as the kernel is sometimes occupied with other tasks, e.g., user interrupts, and also as the interface between user space and kernel space is slower than remaining in either kernel space or user space.

In some cases network processing could be offloaded in part or in whole to the NIC, e.g., using a TCP offload or IPsec offload engine. This could be in kernel space or user space depending on the implementation of the hardware driver.

In some cases the disclosed network processing methods can be used in any of a northbound processing path, a southbound processing path, and a forwarding processing path, where northbound refers to packets generated at packets generated at the host (gateway) and sent toward the core and southbound refers to packets generated at the host (gateway) and sent toward the UE, and forwarding refers to packets that are not generated at the host but forwarded either in the northbound or southbound direction. Packets generated at the host could be packets such as a typical packet used for diagnostics, such as a ping packet.

Overall system performance (Tunnel established Per Second and packet processing) can be optimized by avoiding the inner IP route installation and the lookup. The IPSec tunnel is established only after IKE negotiation is done. Hence it is safe to assume that the inner IP is always reachable via the outer IP.

As shown in FIG. 2, route lookup can be saved and packet processing and establishing of IPSec tunnels can be accelerated. This is very efficient on systems supporting high number of tunnels such as ePDG. Flow 201 shows conventional packet processing. Flow 202 shows optimized packet processing.

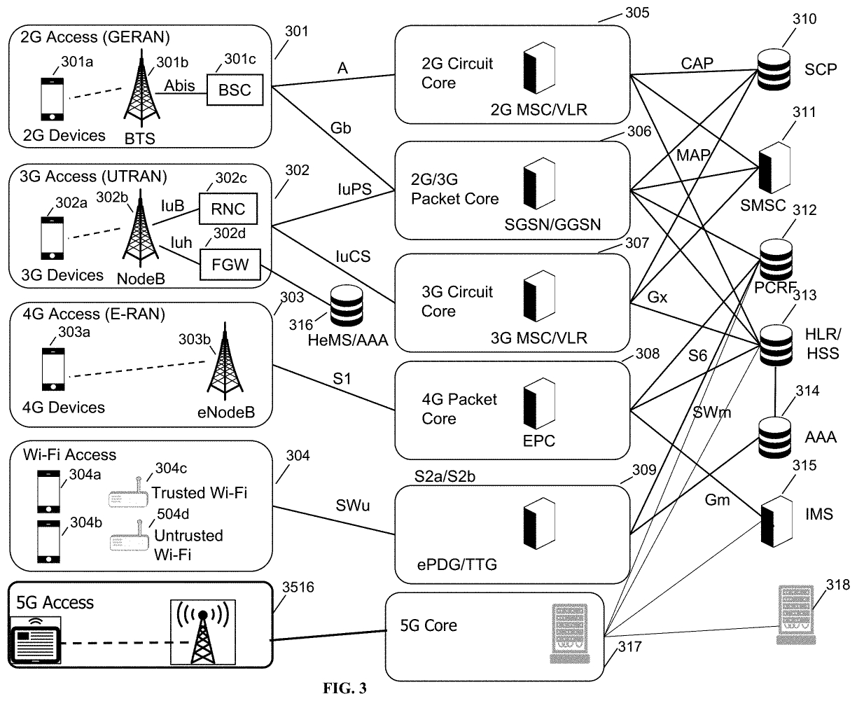

FIG. 3 shows a schematic network architecture diagram for 3G and other-G prior art networks. The diagram shows a plurality of “Gs,” including 2G, 3G, 4G, 5G and Wi-Fi. 2G is represented by GERAN 101, which includes a 2G device 101a, BTS 301b, and BSC 301c . 3G is represented by UTRAN 302, which includes a 3G UE 302a, nodeB 302b, RNC 302c, and femto gateway (FGW, which in 3GPP namespace is also known as a Home nodeB Gateway or HNBGW) 302d . 4G is represented by EUTRAN or E-RAN 303, which includes an LTE UE 303a and LTE eNodeB 303b . Wi-Fi is represented by Wi-Fi access network 304, which includes a trusted Wi-Fi access point 304c and an untrusted Wi-Fi access point 304d . The Wi-Fi devices 304a and 304b may access either AP 304c or 304d . In the current network architecture, each “G” has a core network. 2G circuit core network 305 includes a 2G MSC/VLR; 2G/3G packet core network 306 includes an SGSN/GGSN (for EDGE or UMTS packet traffic); 3G circuit core 307 includes a 3G MSC/VLR; 4G circuit core 308 includes an evolved packet core (EPC); and in some embodiments the Wi-Fi access network may be connected via an ePDG/TTG using S2a /S2b . Each of these nodes are connected via a number of different protocols and interfaces, as shown, to other, non-“G”-specific network nodes, such as the SCP 330, the SMSC 331, PCRF 332, HLR/HSS 333, Authentication, Authorization, and Accounting server (AAA) 334, and IP Multimedia Subsystem (IMS) 335. An HeMS/AAA 336 is present in some cases for use by the 3G UTRAN. The diagram is used to indicate schematically the basic functions of each network as known to one of skill in the art, and is not intended to be exhaustive. For example, 5G core 317 is shown using a single interface to 5G access 316, although in some cases 5G access can be supported using dual connectivity or via a non-standalone deployment architecture.

Noteworthy is that the RANs 301, 302, 303, 304 and 336 rely on specialized core networks 305, 306, 307, 308, 309, 337 but share essential management databases 330, 331, 332, 333, 334, 335, 338. More specifically, for the 2G GERAN, a BSC 301c is required for Abis compatibility with BTS 301b, while for the 3G UTRAN, an RNC 302c is required for Iub compatibility and an FGW 302d is required for Iuh compatibility. These core network functions are separate because each RAT uses different methods and techniques. On the right side of the diagram are disparate functions that are shared by each of the separate RAT core networks. These shared functions include, e.g., PCRF policy functions, AAA authentication functions, and the like. Letters on the lines indicate well-defined interfaces and protocols for communication between the identified nodes.

The system may include 5G equipment. 5G networks are digital cellular networks, in which the service area covered by providers is divided into a collection of small geographical areas called cells. Analog signals representing sounds and images are digitized in the phone, converted by an analog to digital converter and transmitted as a stream of bits. All the 5G wireless devices in a cell communicate by radio waves with a local antenna array and low power automated transceiver (transmitter and receiver) in the cell, over frequency channels assigned by the transceiver from a common pool of frequencies, which are reused in geographically separated cells. The local antennas are connected with the telephone network and the Internet by a high bandwidth optical fiber or wireless backhaul connection.

5G uses millimeter waves which have shorter range than microwaves, therefore the cells are limited to smaller size. Millimeter wave antennas are smaller than the large antennas used in previous cellular networks. They are only a few inches (several centimeters) long. Another technique used for increasing the data rate is massive MIMO (multiple-input multiple-output). Each cell will have multiple antennas communicating with the wireless device, received by multiple antennas in the device, thus multiple bitstreams of data will be transmitted simultaneously, in parallel. In a technique called beamforming the base station computer will continuously calculate the best route for radio waves to reach each wireless device, and will organize multiple antennas to work together as phased arrays to create beams of millimeter waves to reach the device.

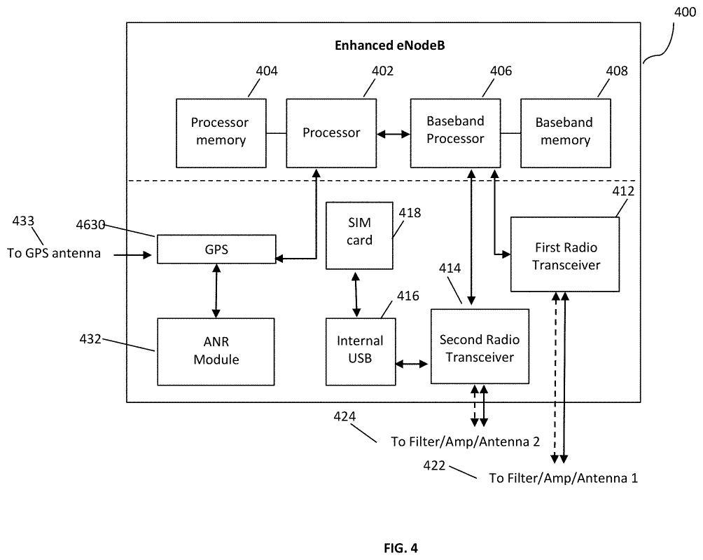

FIG. 4 shows an enhanced eNodeB for performing the methods described herein, in accordance with some embodiments. eNodeB 500 may include processor 402, processor memory 404 in communication with the processor, baseband processor 406, and baseband processor memory 408 in communication with the baseband processor. Mesh network node 400 may also include first radio transceiver 412 and second radio transceiver 414, internal universal serial bus (USB) port 416, and subscriber information module card (SIM card) 418 coupled to USB port 416. In some embodiments, the second radio transceiver 414 itself may be coupled to USB port 416, and communications from the baseband processor may be passed through USB port 416. The second radio transceiver may be used for wirelessly backhauling eNodeB 400.

Processor 402 and baseband processor 406 are in communication with one another. Processor 402 may perform routing functions, and may determine if/when a switch in network configuration is needed. Baseband processor 406 may generate and receive radio signals for both radio transceivers 412 and 414, based on instructions from processor 402. In some embodiments, processors 402 and 406 may be on the same physical logic board. In other embodiments, they may be on separate logic boards.

Processor 402 may identify the appropriate network configuration, and may perform routing of packets from one network interface to another accordingly. Processor 402 may use memory 404, in particular to store a routing table to be used for routing packets. Baseband processor 406 may perform operations to generate the radio frequency signals for transmission or retransmission by both transceivers 410 and 412. Baseband processor 406 may also perform operations to decode signals received by transceivers 412 and 414. Baseband processor 406 may use memory 408 to perform these tasks.

The first radio transceiver 412 may be a radio transceiver capable of providing LTE eNodeB functionality, and may be capable of higher power and multi-channel OFDMA. The second radio transceiver 414 may be a radio transceiver capable of providing LTE UE functionality. Both transceivers 412 and 414 may be capable of receiving and transmitting on one or more LTE bands. In some embodiments, either or both of transceivers 412 and 414 may be capable of providing both LTE eNodeB and LTE UE functionality. Transceiver 412 may be coupled to processor 402 via a Peripheral Component Interconnect-Express (PCI-E) bus, and/or via a daughtercard. As transceiver 414 is for providing LTE UE functionality, in effect emulating a user equipment, it may be connected via the same or different PCI-E bus, or by a USB bus, and may also be coupled to SIM card 418. First transceiver 412 may be coupled to first radio frequency (RF) chain (filter, amplifier, antenna) 422, and second transceiver 414 may be coupled to second RF chain (filter, amplifier, antenna) 424.

SIM card 418 may provide information required for authenticating the simulated UE to the evolved packet core (EPC). When no access to an operator EPC is available, a local EPC may be used, or another local EPC on the network may be used. This information may be stored within the SIM card, and may include one or more of an international mobile equipment identity (IMEI), international mobile subscriber identity (IMSI), or other parameter needed to identify a UE. Special parameters may also be stored in the SIM card or provided by the processor during processing to identify to a target eNodeB that device 400 is not an ordinary UE but instead is a special UE for providing backhaul to device 400.

Wired backhaul or wireless backhaul may be used. Wired backhaul may be an Ethernet-based backhaul (including Gigabit Ethernet), or a fiber-optic backhaul connection, or a cable-based backhaul connection, in some embodiments. Additionally, wireless backhaul may be provided in addition to wireless transceivers 412 and 414, which may be Wi-Fi 802.11a/b/g/n/ac/ad/ah, Bluetooth, ZigBee, microwave (including line-of-sight microwave), or another wireless backhaul connection. Any of the wired and wireless connections described herein may be used flexibly for either access (providing a network connection to UEs) or backhaul (providing a mesh link or providing a link to a gateway or core network), according to identified network conditions and needs, and may be under the control of processor 402 for reconfiguration.

A GPS module 430 may also be included, and may be in communication with a GPS antenna 432 for providing GPS coordinates, as described herein. When mounted in a vehicle, the GPS antenna may be located on the exterior of the vehicle pointing upward, for receiving signals from overhead without being blocked by the bulk of the vehicle or the skin of the vehicle. Automatic neighbor relations (ANR) module 432 may also be present and may run on processor 402 or on another processor, or may be located within another device, according to the methods and procedures described herein.

Other elements and/or modules may also be included, such as a home eNodeB, a local gateway (LGW), a self-organizing network (SON) module, or another module. Additional radio amplifiers, radio transceivers and/or wired network connections may also be included.

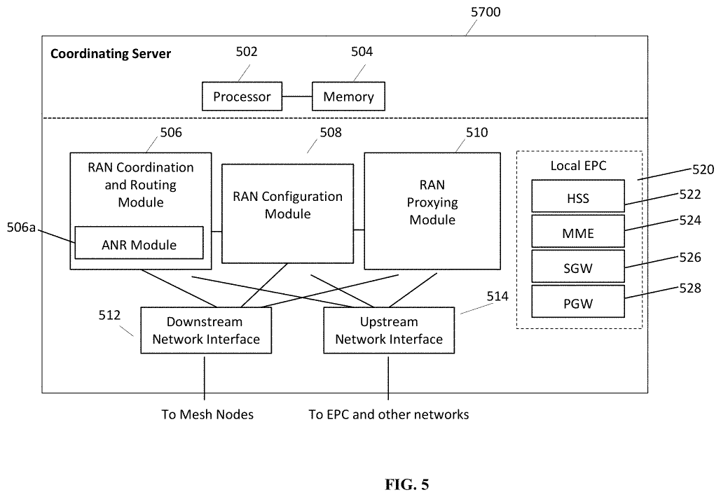

FIG. 5 shows a coordinating server for providing services and performing methods as described herein, in accordance with some embodiments. Coordinating server 500 includes processor 502 and memory 504, which are configured to provide the functions described herein. Also present are radio access network coordination/routing (RAN Coordination and routing) module 506, including ANR module 506a, RAN configuration module 508, and RAN proxying module 510. The ANR module 506a may perform the ANR tracking, PCI disambiguation, ECGI requesting, and GPS coalescing and tracking as described herein, in coordination with RAN coordination module 506 (e.g., for requesting ECGIs, etc.). In some embodiments, coordinating server 500 may coordinate multiple RANs using coordination module 506. In some embodiments, coordination server may also provide proxying, routing virtualization and RAN virtualization, via modules 510 and 508. In some embodiments, a downstream network interface 512 is provided for interfacing with the RANs, which may be a radio interface (e.g., LTE), and an upstream network interface 514 is provided for interfacing with the core network, which may be either a radio interface (e.g., LTE) or a wired interface (e.g., Ethernet).

Coordinator 500 includes local evolved packet core (EPC) module 520, for authenticating users, storing and caching priority profile information, and performing other EPC-dependent functions when no backhaul link is available. Local EPC 520 may include local HSS 522, local MME 524, local SGW 526, and local PGW 528, as well as other modules. Local EPC 520 may incorporate these modules as software modules, processes, or containers. Local EPC 520 may alternatively incorporate these modules as a small number of monolithic software processes. Modules 506, 508, 510 and local EPC 520 may each run on processor 502 or on another processor, or may be located within another device.

In any of the scenarios described herein, where processing may be performed at the cell, the processing may also be performed in coordination with a cloud coordination server. A mesh node may be an eNodeB. An eNodeB may be in communication with the cloud coordination server via an X2 protocol connection, or another connection. The eNodeB may perform inter-cell coordination via the cloud communication server, when other cells are in communication with the cloud coordination server. The eNodeB may communicate with the cloud coordination server to determine whether the UE has the ability to support a handover to Wi-Fi, e.g., in a heterogeneous network.

Although the methods above are described as separate embodiments, one of skill in the art would understand that it would be possible and desirable to combine several of the above methods into a single embodiment, or to combine disparate methods into a single embodiment. For example, all of the above methods could be combined. In the scenarios where multiple embodiments are described, the methods could be combined in sequential order, or in various orders as necessary.

Although the above systems and methods for providing interference mitigation are described in reference to the Long Term Evolution (LTE) standard, one of skill in the art would understand that these systems and methods could be adapted for use with other wireless standards or versions thereof. The inventors have understood and appreciated that the present disclosure could be used in conjunction with various network architectures and technologies. Wherever a 4G technology is described, the inventors have understood that other RATs have similar equivalents, such as a gNodeB for 5G equivalent of eNB. Wherever an MME is described, the MME could be a 3G RNC or a 5G AMF/SMF. Additionally, wherever an MME is described, any other node in the core network could be managed in much the same way or in an equivalent or analogous way, for example, multiple connections to 4G EPC PGWs or SGWs, or any other node for any other RAT, could be periodically evaluated for health and otherwise monitored, and the other aspects of the present disclosure could be made to apply, in a way that would be understood by one having skill in the art.

Additionally, the inventors have understood and appreciated that it is advantageous to perform certain functions at a coordination server, such as the Parallel Wireless HetNet Gateway, which performs virtualization of the RAN towards the core and vice versa, so that the core functions may be statefully proxied through the coordination server to enable the RAN to have reduced complexity. Therefore, at least four scenarios are described: (1) the selection of an MME or core node at the base station; (2) the selection of an MME or core node at a coordinating server such as a virtual radio network controller gateway (VRNCGW); (3) the selection of an MME or core node at the base station that is connected to a 5G-capable core network (either a 5G core network in a 5G standalone configuration, or a 4G core network in 5G non-standalone configuration); (4) the selection of an MME or core node at a coordinating server that is connected to a 5G-capable core network (either 5G SA or NSA). In some embodiments, the core network RAT is obscured or virtualized towards the RAN such that the coordination server and not the base station is performing the functions described herein, e.g., the health management functions, to ensure that the RAN is always connected to an appropriate core network node. Different protocols other than S1AP, or the same protocol, could be used, in some embodiments.

In some embodiments, the software needed for implementing the methods and procedures described herein may be implemented in a high level procedural or an object-oriented language such as C, C++, C#, Python, Java, or Perl. The software may also be implemented in assembly language if desired. Packet processing implemented in a network device can include any processing determined by the context. For example, packet processing may involve high-level data link control (HDLC) framing, header compression, and/or encryption. In some embodiments, software that, when executed, causes a device to perform the methods described herein may be stored on a computer-readable medium such as read-only memory (ROM), programmable-read-only memory (PROM), electrically erasable programmable-read-only memory (EEPROM), flash memory, or a magnetic disk that is readable by a general or special purpose-processing unit to perform the processes described in this document. The processors can include any microprocessor (single or multiple core), system on chip (SoC), microcontroller, digital signal processor (DSP), graphics processing unit (GPU), or any other integrated circuit capable of processing instructions such as an x86 microprocessor.

In some embodiments, the radio transceivers described herein may be base stations compatible with a Long Term Evolution (LTE) radio transmission protocol or air interface. The LTE-compatible base stations may be eNodeBs. In addition to supporting the LTE protocol, the base stations may also support other air interfaces, such as UMTS/HSPA, CDMA/CDMA2000, GSM/EDGE, GPRS, EVDO, 2G, 3G, 5G, TDD, or other air interfaces used for mobile telephony.

In some embodiments, the base stations described herein may support Wi-Fi air interfaces, which may include one or more of IEEE 802.11a/b/g/n/ac/af/p/h. In some embodiments, the base stations described herein may support IEEE 802.16 (WiMAX), to LTE transmissions in unlicensed frequency bands (e.g., LTE-U, Licensed Access or LA-LTE), to LTE transmissions using dynamic spectrum access (DSA), to radio transceivers for ZigBee, Bluetooth, or other radio frequency protocols, or other air interfaces.

The foregoing discussion discloses and describes merely exemplary embodiments of the present invention. In some embodiments, software that, when executed, causes a device to perform the methods described herein may be stored on a computer-readable medium such as a computer memory storage device, a hard disk, a flash drive, an optical disc, or the like. As will be understood by those skilled in the art, the present invention may be embodied in other specific forms without departing from the spirit or essential characteristics thereof. For example, wireless network topology can also apply to wired networks, optical networks, and the like. The methods may apply to 5G networks, GSM networks, LTE-compatible networks, to UMTS-compatible networks, or to networks for additional protocols that utilize radio frequency data transmission. Various components in the devices described herein may be added, removed, split across different devices, combined onto a single device, or substituted with those having the same or similar functionality.

Although the present disclosure has been described and illustrated in the foregoing example embodiments, it is understood that the present disclosure has been made only by way of example, and that numerous changes in the details of implementation of the disclosure may be made without departing from the spirit and scope of the disclosure, which is limited only by the claims which follow. Various components in the devices described herein may be added, removed, or substituted with those having the same or similar functionality. Various steps as described in the figures and specification may be added or removed from the processes described herein, and the steps described may be performed in an alternative order, consistent with the spirit of the invention. Features of one embodiment may be used in another embodiment.

1. A method for providing accelerated lookup for IPsec IP encapsulating security payload (ESP) tunnels in a kernel-space network stack, comprising:
receiving an IP packet at a network stack;
performing IPsec policy lookup of the IP packet to identify an ESP tunnel IP, thereby ensuring an inner IP is routable at an other end of the tunnel without installing a route for the inner IP at the network stack;
performing a route lookup for the tunnel IP; and
sending the IP packet across the ESP tunnel.

2. The method of claim 1, further comprising using the accelerated lookup for a non-IPsec implementation using GPRS Tunneling Protocol (GTP) tunnels.

3. The method of claim 1, further comprising using the accelerated lookup for instruction-set level hardware-accelerated network processing.

4. The method of claim 1, further comprising using the accelerated lookup for network stack processing in a virtualized environment, the virtualized environment comprising at least one of a virtual machine and containers.

5. The method of claim 1, further comprising using the accelerated lookup for distributed network stack processing.

6. The method of claim 1, further comprising using the accelerated lookup for top-of-rack network stack processing.

7. The method of claim 1, wherein in a kernel-space networking stack, passing data and sending a packet by a first user to a second user includes sending the packet to and through a operating system (OS) kernel.

8. The method of claim 7, wherein sending a packet further comprises adding IP headers at the OS kernel, performing IPsec processing in the kernel, handing off the processed packet to a network interface card (NIC), and sending, by the NIC, the packet out.

9. The method of claim 1, further comprising sending the packet to a second user host, wherein the packet goes to the second user host's kernel, is processed there, then to a socket interface at the second user host's kernel, then to the user space application on the second user host.

10. The method of claim 1, further comprising offloading a plurality of network tasks to a user space networking stack by a user space application invoking processing by the user space networking library.

11. The method of claim 1, wherein offloading is performed using a TCP offload or IPsec offload engine.

12. A non-transitory computer-readable medium containing instructions for providing accelerated lookup for IPsec IP encapsulating security payload (ESP) tunnels which, when executed, cause a system to perform steps comprising:
receiving an IP packet at a network stack;
performing IPsec policy lookup of an ESP tunnel for the IP packet, and thereby ensuring that an inner IP is routable at an other end of the ESP tunnel;
performing a route lookup for an ESP tunnel IP; and
sending the IP packet across the ESP tunnel using the ESP tunnel IP route.

13. The computer-readable medium of claim 12, the instructions further comprising using the accelerated lookup for at least one of: an IPsec implementation in a kernel-space network stack, a non-IPsec implementation using GTP tunnels, instruction set level, hardware/firmware-accelerated network processing, network stack processing in a virtualized environment using a virtual machine, network stack processing in a virtualized environment using containers, distributed network stack processing, and top-of-rack network stack processing,

14. The computer-readable medium of claim 12, the instructions further comprising sending a packet by a first user to a second user via a kernel-space networking stack.

15. The computer-readable medium of claim 12, the instructions further comprising: adding IP headers at the kernel, performing IPsec processing in the kernel, handing off the processed packet to a network interface card (NIC), and sending the packet out at the NIC.

16. The computer-readable medium of claim 12, the instructions further comprising sending the packet to a user space application on a second user host.

17. The computer-readable medium of claim 12, the instructions further comprising offloading using a TCP offload or IPsec offload engine.
